(19) United States
(12) Patent Application Publication
(10) Pub. No.: US 2007/0002240 A1
(43) Pub. Date: Jan. 4, 2007

(54) LIQUID CRYSTAL DISPLAY PANEL AND LIQUID CRYSTAL DISPLAY DEVICE

(76) Inventors: Hao-Ting Tien, Taipei County (TW); Chiu-Chen Lun, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,307

(22) Filed: Jul. 29, 2005

(30) Foreign Application Priority Data
Jul. 1, 2005 (TW) 94122271

(51) Int. Cl. G02F 1/1343

(52) U.S. Cl. 349/139

(57) ABSTRACT

A liquid crystal display panel including a first substrate, a second substrate and a liquid crystal layer is provided. The first substrate has active devices and pixel electrodes thereon, wherein each pixel electrode includes first strips. The second substrate has a common electrode thereon, wherein the common electrode includes second strips, and the second strips are aligned to the first strips. The liquid crystal layer is disposed between the first substrate and the second substrate, wherein the liquid crystal layer includes a plurality of vertically aligned liquid crystal molecules. The vertically aligned liquid crystal molecules are perpendicular to the two substrates when no electric filed is formed between the pixel electrodes and the common electrode. The vertically aligned liquid crystal molecules arrange in accordance with the distribution of an electric field when a driving voltage is applied between the pixel electrodes and the common electrode.

### CROSS-REFERENCE TO RELATED APPLICATION

This application claims the priority benefit of Taiwan application serial no. 94122271, filed Jul. 1, 2005. All disclosure of the Taiwan application is incorporated herein by reference.

### BACKGROUND OF THE INVENTION

1. Field of the Invention

The present invention generally relates to a liquid crystal display (LCD) panel and a liquid crystal display device. More particularly, the present invention relates to a vertically-aligned liquid crystal display panel and a vertically-aligned liquid crystal display device.

2. Description of Related Art

Liquid crystal display devices have rapidly become prevalent because they can easily display a large volume of information, displacing CRT type display devices. Conventionally, the twisted nematic mode has been mainly used, in which, the liquid crystal molecules are inserted between two substrates and are twist oriented by rotation of the molecular axis direction by 90 degrees in plan view, and images are displayed by rotating the director in the vertical direction with respect to the substrates by a vertical electric field.

Currently, because fast-switching LCD is required, an optically compensated bend (OCB) mode LCD exhibiting fast response time less than 10 ms is developed. The liquid crystal cell used in the OCB mode LCD devices is formed by inserting a liquid crystal layer between two substrates, and the liquid crystal layer is oriented at the interface of the substrate surfaces with a tilt angle range. When no electric field is formed between the two substrates in the above state, the tilt angle decreases to zero towards the center of the liquid crystal cell. The tilt angle is reduced towards the center and the tilt angle becomes zero at the center of the cell gap, where the liquid crystal molecules are oriented in parallel to both the two substrates. Because the liquid crystal molecules at the surfaces of the two substrates are parallel aligned so that light leak may occur at a normally black state. In order to improve the contract of the said OCB mode LCD device, phase compensating plates are usually used. But using phase compensating plates increases LCD manufacturing cost.

Additionally, in the OCB mode LCD, it is necessary for the liquid crystal molecules by the application of a high voltage to the cell gap, to be rearranged in a bend arrangement, wherein the liquid crystal molecules at the center of the cell gap stand up and the tilt angle of the liquid crystal molecules at the interface with the substrate becomes zero. However, this high voltage for the liquid crystal molecules increases power consuming.

### SUMMARY OF THE INVENTION

Accordingly, the present invention is directed to a liquid crystal display panel having no light leak at a normally black state.

The present invention is directed to a liquid crystal display device having low power consuming and capable of reducing manufacturing cost.

According to an embodiment of the present invention, a liquid crystal display panel including a first substrate, a second substrate and a liquid crystal layer is provided. The first substrate includes a plurality of active devices and a plurality of pixel electrodes thereon, wherein each pixel electrode comprises a plurality of first strips. The second substrate has a common electrode thereon, wherein the common electrode comprises a plurality of second strips, and the second strips are aligned to the first strips. The liquid crystal layer is disposed between the first substrate and the second substrate, wherein the liquid crystal layer comprises a plurality of vertically aligned liquid crystal molecules, and the vertically aligned liquid crystal molecules are perpendicular to the substrate when no electric filed is formed between the pixel electrodes and the common electrode. According to an embodiment of the present invention, the vertically aligned liquid crystal molecules arrange in accordance with the distribution of an electric field when a driving voltage is applied between the pixel electrodes and the common electrode.

According to another embodiment of the present invention, a liquid crystal display device comprising a liquid crystal display panel, a backlight module, a lower optical film and an upper optical film is provided. The liquid crystal display panel includes a first substrate, a second substrate and a liquid crystal layer. The first substrate includes a plurality of active devices and a plurality of pixel electrodes thereon, wherein each pixel electrode comprises a plurality of first strips. The second substrate has a common electrode thereon, wherein the common electrode comprises a plurality of second strips, and the second strips are aligned to the first strips. The liquid crystal layer is disposed between the first substrate and the second substrate, wherein the liquid crystal layer comprises a plurality of vertically aligned liquid crystal molecules, and vertically aligned the liquid crystal molecules are perpendicular to the substrate when no electric filed is formed between the pixel electrodes and the common electrode. According to an embodiment of the present invention, the vertically aligned liquid crystal molecules arrange in accordance with the distribution of an electric field when a driving voltage is applied between the pixel electrodes and the common electrode. Besides, the backlight module is disposed on a back side of the liquid crystal display panel. The lower optical film is disposed between the liquid crystal display panel and the backlight module. The upper optical film disposed on a front side of the liquid crystal display panel.

According to an embodiment of the present invention, the first strips have a thickness in a range of 0.1˜1 μm. In addition, the second strips have a thickness in a range of 0.1˜1 μm.

According to an embodiment of the present invention, the first strips have a width in a range of 4˜20 μm. In addition, the second strips have a width in a range of 4˜20 μm.

According to an embodiment of the present invention, a space between two of the first strips is between 10˜30 μm. In addition, a space between two of the second strips is between 10˜30 μm.

According to an embodiment of the present invention, the active devices are thin film transistors.

According to an embodiment of the present invention, the second substrate further comprises a color filter array thereon, and the color filter array is underneath the common electrode.

According to an embodiment of the present invention, the lower optical film comprises a polarizing film. In addition, the upper optical film comprises a polarizing film.

According to an embodiment of the present invention, the shape of the first strips of the pixel electrode and the second strips of the common electrode are identical.

In the present invention, the first strips of the pixel electrode are aligned to the second strips of the common electrode, and the liquid crystal molecules arranged as a bend mode when a driving voltage is applied between the pixel electrode and the common electrode so that the liquid crystal display panel is like the OCB mode LCD. In addition, the liquid crystal molecules in the LCD panel are perpendicular to the two substrates when no electric filed is formed between the pixel electrode and the common electrode so that no light leak occurs when the LCD panel is at a normally black state.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram showing a liquid crystal display panel when no electric field is formed between the pixel electrode and the common electrode according to an embodiment of the present invention.

FIG. 2 is a diagram showing a liquid crystal display panel when a driving voltage is applied between the pixel electrode and the common electrode according to an embodiment of the present invention.

FIG. 3A is a top view showing one pixel unit on a first substrate according to an embodiment of the present invention.

FIG. 3B is a top view showing one pixel unit on a second substrate according to an embodiment of the present invention.

FIG. 4A is a top view showing one pixel unit on a first substrate according to another embodiment of the present invention.

FIG. 4B is a top view showing one pixel unit on a second substrate according to another embodiment of the present invention.

FIG. 5 is cross-sectional view showing a liquid crystal display device according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

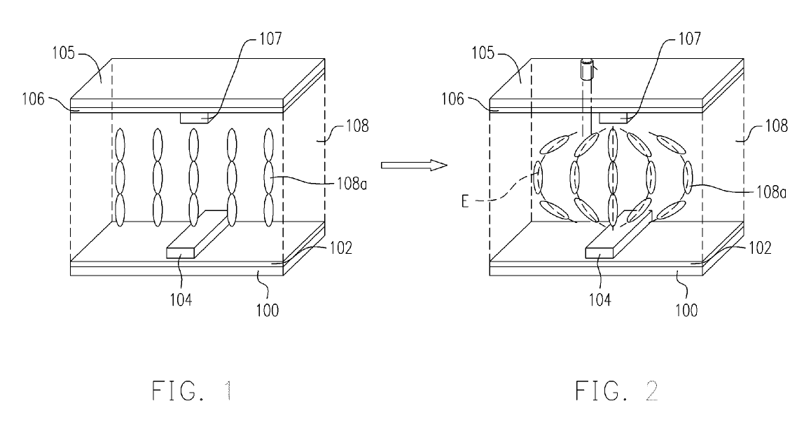

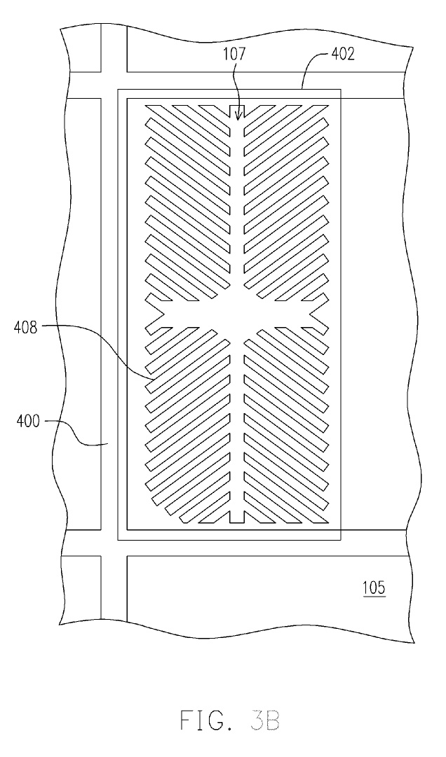

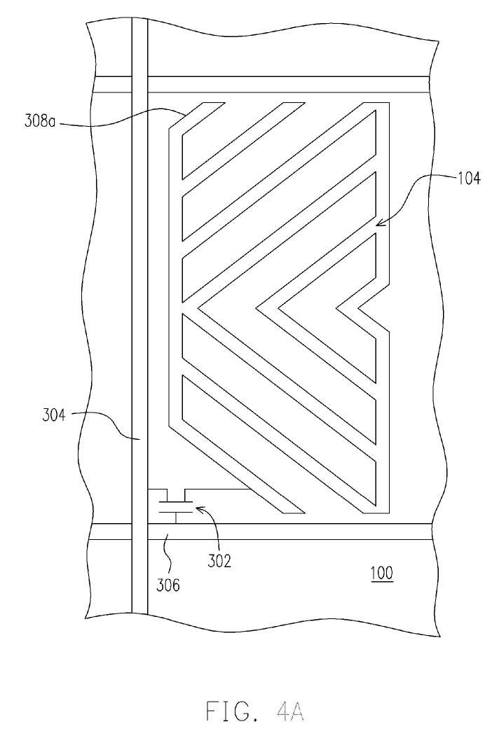

FIG. 1 is a diagram showing a liquid crystal display panel when no electric field is formed between the pixel electrode and the common electrode according to an embodiment of the present invention. As shown in FIG. 1, the liquid crystal display panel comprises a first substrate 100 having active devices 102 and pixel electrodes 104 thereon, a second substrate 105 having a common electrode 107 thereon and a liquid crystal layer 108 between the first substrate 100 and the second substrate 105. As shown in FIG. 3A, the active devices 102 of FIG. 1 comprise scan lines 306, data lines 304 and thin film transistors 302 electrically connected with the scan lines 306 and the data lines 304. Each pixel electrode 104 comprises a plurality of first strips 308. In addition, as shown in FIG. 3B, the common electrode 107 on the second substrate 105 comprises a plurality of second stripes 408. In an embodiment, the second substrate 105 further comprises a color filter array 106 thereon, and color filter array 106 is underneath the common electrode 107. The color filter array 106 includes a black matrix 400 and color resins (red, green and blue) 402, for example.

In particular, as shown in FIGS. 1, 3A and 3B, the first strips 308 on the first substrate 100 are aligned to the second strips 408 on the second substrate 105. In details, the first strips on the first substrate 100 and the second strips 408 on the second substrate 105 have similar patterns and they are arranged correspondingly. In an embodiment, the first strips 308 have a thickness in a range of 0.1˜1 μm, for example. The second strips 408 have a thickness in a range of 0.1˜1 μm, for example. According to an embodiment, the first strips 308 have a width in a range of 4˜20 μm, for example. The second strips 408 have a width in a range of 4˜20 μm, for example. In an embodiment, a space between two of the first strips 308 is between 10˜30 μm, for example. In addition, a space between two of the second strips 408 is between 10˜30 μm, for example. In an embodiment of the present invention, the shape of the first strips 308 of the pixel electrode 104 and the second strips 408 of the common electrode 107 are identical.

As shown in FIG. 1, the liquid crystal layer 108 between the first substrate 100 and the second substrate 105 comprises a plurality of liquid crystal molecules 108a. In an embodiment, the liquid crystal molecules 108a are vertically aligned liquid crystal molecules. The liquid crystal molecules 108a are perpendicular to the two substrates 100, 105 when no electric filed is formed between the pixel electrode 104 and the common electrode 107, and this state is a so-called normally black state. Since the liquid crystal molecules 108a are perpendicular to the two substrates 100, 105 when no electric filed is formed between the pixel electrode 104 and the common electrode 107, the LCD panel of the present invention is a so-called vertically aligned LCD panel.

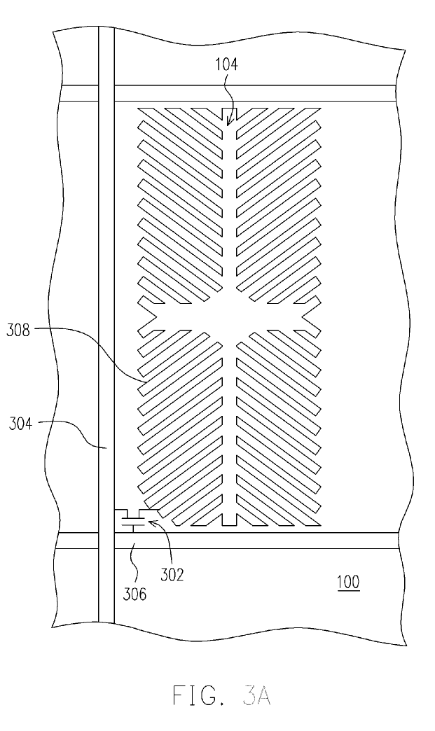

When a voltage is applied between the common electrode 107 and the pixel electrodes 104, as shown in FIG. 2, an electric filed E is formed between the common electrode 107 and the pixel electrodes 104. In particular, the distribution of the electric field E between the common electrode 107 and the pixel electrodes 104 presents bending so that the liquid crystal molecules 108a parallel to the electric field E arrange as a bend mode. In other words, the liquid crystal molecules 108a arrange in accordance with the distribution of the electric field E when a driving voltage is applied between the pixel electrodes 104 and the common electrode 107. Therefore, the liquid crystal display panel of the present invention is like an OCB mode LCD.

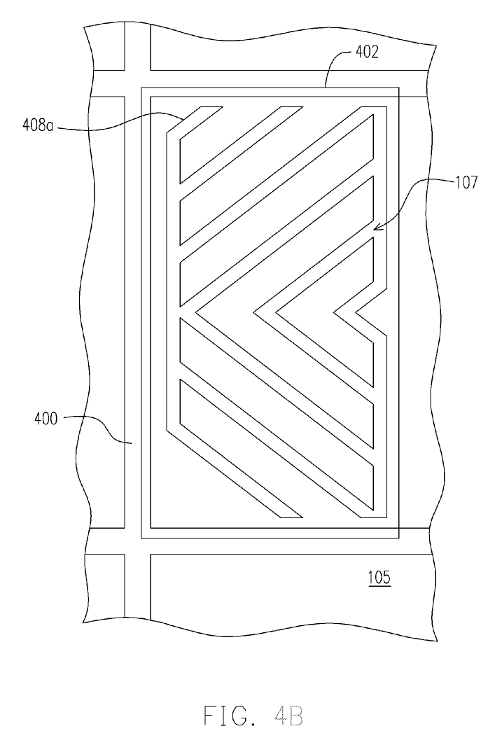

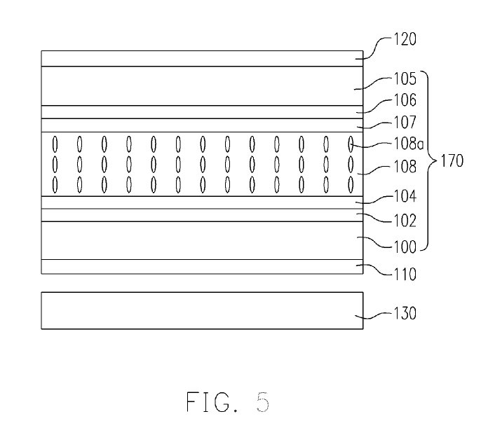

The pixel electrode 104 may also be constituted of another strip patterns, as shown in FIG. 4A. These strips 308a of FIG. 4A are different from the strips 308 in FIG. 3A. If the pixel electrode 104 is composed of the strips 308a, the common electrode 107 should be constituted of the strips 408a (as shown in FIG. 4B) correspondingly. Hence, the strips 308a of the pixel electrode 104 on the first substrate 100 may aligned to the strips 408a of the common electrode 107 on the second substrate 105.

FIG. 5 is cross-sectional view showing a liquid crystal display device according to an embodiment of the present invention. As shown in FIG. 5, the present invention also provides a liquid crystal display device comprising a liquid crystal display panel 170, a backlight module 130, a lower optical film 110 and an upper optical film 120. The liquid crystal display panel 170 comprises a first substrate 100 having active devices 102 and pixel electrodes 104 thereon, a second substrate 105 having a common electrode 107 thereon and a liquid crystal layer 108 between the first substrate 100 and the second substrate 105. The second substrate 105 may further comprise a color filter array 106 thereon. Each pixel electrode 104 comprises a plurality of first strips, and the common electrode 107 on the second substrate 105 comprises a plurality of second stripes. In particular, the first strips of the pixel electrode 104 are aligned to the second strips of the common electrode 107. The thickness, width and space distance of the first and second strips have been described as above mentioned. The liquid crystal layer 108 comprises a plurality of liquid crystal molecules 108a, and they are perpendicular to the two substrates 100, 105 when no electric filed is formed between the pixel electrode 104 and the common electrode 107.

The backlight module 130 is disposed on a back side of the liquid crystal display panel 170. The backlight module 130 is, for example, a directly type backlight module or an edge type backlight module. The lower optical film 110 is disposed between the liquid crystal display panel 170 and the backlight module 130. The lower optical film 110 comprises a polarizing film, for example. The lower film 110 may also further comprises another optical film, such as a diffusion film and a wide-viewing angle film, for example. The upper optical film 120 is disposed on a front side of the liquid crystal display panel 170. The upper optical film 120 comprises a polarizing film, for example. The upper film 120 may also further comprises another optical film, such as a diffusion film and a wide-viewing angle film, for example.

In the LCD panel and the LCD device of the present invention, the first strips of the pixel electrode are aligned to the second strips of the common electrode, and the liquid crystal molecules arrange as a bend mode when a driving voltage is applied between the pixel electrode and the common electrode so that the LCD panel/device are like a OCB mode LCD panel/device. In addition, the liquid crystal molecules are perpendicular to the two substrates when no electric filed is formed between the pixel electrode and the common electrode so that no light leak occurs when the LCD panel is at a normally black state. Therefore, additional phase compensating plates are not required, and the LCD manufacturing cost can be reduced.

Furthermore, the liquid crystal molecules on the surfaces of the two substrates are also perpendicular to the two substrates when no electric filed is formed between the pixel electrode and the common electrode. When driving the liquid crystal molecules as a bend mode, an additional initial high voltage to the cell gap is not required so that the power consuming of the LCD device can be reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A liquid crystal display panel, comprising:
a first substrate comprising a plurality of active devices and a plurality of pixel electrodes thereon, wherein each pixel electrode comprises a plurality of first strips;
a second substrate comprising a common electrode thereon, wherein the common electrode comprises a plurality of second strips, and the second strips are aligned to the first strips; and
a liquid crystal layer disposed between the first substrate and the second substrate, wherein the liquid crystal layer comprises a plurality of vertically aligned liquid crystal molecules,
wherein the vertically aligned liquid crystal molecules are perpendicular to the first and second substrates when no electric field is formed between the pixel electrodes and the common electrode,
the vertically aligned liquid crystal molecules arrange in accordance with the distribution of an electric field when a driving voltage is applied between the pixel electrodes and the common electrode.

2. The liquid crystal display panel according to claim 1, wherein the first strips have a thickness in a range of 0.1˜1 μm.

3. The liquid crystal display panel according to claim 1, wherein the second strips have a thickness in a range of 0.1˜1 μm.

4. The liquid crystal display panel according to claim 1, wherein the first strips have a width in a range of 4˜20 μm.

5. The liquid crystal display panel according to claim 1, wherein the second strips have a width in a range of 4˜20 μm.

6. The liquid crystal display panel according to claim 1, wherein a space between two of the first strips is between 10˜30 μm.

7. The liquid crystal display panel according to claim 1, wherein a space between two of the second strips is between 10˜30 μm.

8. The liquid crystal display panel according to claim 1, wherein the active devices are thin film transistors.

9. The liquid crystal display panel according to claim 1, further comprising a color filter array on the second substrate underneath the common electrode.

10. The liquid crystal display panel according to claim 1, wherein the shape of the first strips of the pixel electrode and the second strips of the common electrode are identical.

11. A liquid crystal display device, comprising:
a liquid crystal display panel, comprising:
a first substrate comprising a plurality of active devices and a plurality of pixel electrodes thereon, wherein each pixel electrode comprises a plurality of first strips;
a second substrate comprising a common electrode thereon, wherein the common electrode comprises a plurality of second strips, and the second strips are aligned to the first strips; and
a liquid crystal layer disposed between the first substrate and the second substrate, wherein the liquid crystal layer comprises a plurality of vertically aligned liquid crystal molecules,
wherein the vertically aligned liquid crystal molecules are perpendicular to the first and second substrates when no electric field is formed between the pixel electrodes and the common electrode,
the vertically aligned liquid crystal molecules arrange in accordance with the distribution of an electric field when a driving voltage is applied between the pixel electrodes and the common electrode;
a backlight module, disposed on a back side of the liquid crystal display panel;
a lower optical film disposed between the liquid crystal display panel and the backlight module; and
an upper optical film disposed on a front side of the liquid crystal display panel.

12. The liquid crystal display device according to claim 11, wherein the first strips have a thickness in a range of 0.1˜1 μm.

13. The liquid crystal display device according to claim 11, wherein the second strips have a thickness in a range of 0.1˜1 μm.

14. The liquid crystal display device according to claim 11, wherein the first strips have a width in a range of 4˜20 μm.

15. The liquid crystal display device according to claim 11, wherein the second strips have a width in a range of 4˜20 μm.

16. The liquid crystal display device according to claim 11, wherein a space between two of the first strips is between 10˜30 μm.

17. The liquid crystal display device according to claim 11, wherein a space between two of the second strips is between 10˜30 μm.

18. The liquid crystal display device according to claim 11, wherein the active devices are thin film transistors.

19. The liquid crystal display device according to claim 11, further comprising a color filter array on the second substrate underneath the common electrode.

20. The liquid crystal display device according to claim 11, wherein the lower optical film comprises a polarizing film.

21. The liquid crystal display device according to claim 11, wherein the upper optical film comprises a polarizing film.

22. The liquid crystal display device according to claim 11, wherein the shape of the first strips of the pixel electrode and the second strips of the common electrode are identical.
